(19) United States
(12) Patent Application Publication
(10) Pub. No.: US 2025/0215877 A1
(43) Pub. Date: Jul. 3, 2025

(54) ELECTRIC COMPRESSOR

(71) Applicant: KABUSHIKI KAISHA TOYOTA JIDOSHOKKI, Kariya-shi, Aichi-ken (JP)

(72) Inventors: Koki SHINOHARA, Kariya-shi (JP); Yusuke KINOSHITA, Kariya-shi (JP); Yumin HISHINUMA, Kariya-shi (JP); Junya YANO, Kariya-shi (JP)

(73) Assignee: KABUSHIKI KAISHA TOYOTA JIDOSHOKKI, Kariya-shi, Aichi-ken (JP)

(21) Appl. No.: 18/850,653

(22) PCT Filed: Mar. 27, 2023
(86) PCT No.: PCT/JP2023/012254

§ 371 Date: Sep. 25, 2024

(30) Foreign Application Priority Data
Mar. 30, 2022 (JP) 2022-057339

(51) Int. Cl. F04C 29/04; F04C 18/02; H02K 11/33

(52) U.S. Cl. CPC F04C 29/047; F04C 18/0215; H02K 11/33

(57) ABSTRACT

A switching element includes a conductive member and a plastic member having a rectangular parallelepiped shape. The plastic member includes a first end surface, a second end surface, and a first side surface. The conductive member includes a heat generating portion exposed on the first side surface. The switching element is arranged in an inverter-accommodating chamber such that the longitudinal direction of the plastic member extends in an axial direction of a rotary shaft. A heat dissipation member made of metal is arranged between the switching element and a partitioning wall. The heat dissipation member includes a first heat dissipation portion arranged between the heat generating portion and the partitioning wall, and a second heat dissipation portion that is continuous with the first heat dissipation portion and arranged between the second end surface and the partitioning wall.

### TECHNICAL FIELD

The present invention relates to a motor-driven compressor.

### BACKGROUND ART

A motor-driven compressor includes a rotary shaft, an electric motor that rotates the rotary shaft, a compression unit that compresses fluid through rotation of the rotary shaft, an inverter that drives the electric motor, and a housing. The inverter includes a switching element. The housing includes a partitioning wall that separates a suction chamber and an inverter-accommodating chamber from each other. The suction chamber accommodates the electric motor and draws in fluid, and the inverter-accommodating chamber accommodates the inverter.

In the motor-driven compressor disclosed in Patent Literature 1, the switching element is pressed against the partitioning wall by a pressing fixture. The switching element is cooled by fluid, drawn into the suction chamber, through the partitioning wall.

### CITATION LIST

### Patent Literature

Patent Literature 1: Japanese Laid-Open Patent Publication No. 2015-81539

### SUMMARY OF INVENTION

### Technical Problem

In such a motor-driven compressor, it is desired that the cooling performance of the switching element be improved.

### Solution to Problem

In one general aspect of the present invention, a motor-driven compressor is provided. The motor-driven compressor includes a rotary shaft, an electric motor that rotates the rotary shaft, a compression unit that compresses a fluid through rotation of the rotary shaft, an inverter that drives the electric motor and includes a switching element, and a metal housing including a partitioning wall that separates a suction chamber and an inverter-accommodating chamber from each other. The suction chamber accommodates the electric motor and draws in the fluid. The inverter-accommodating chamber accommodates the inverter. The switching element includes a conductive member including a main portion and a pin projecting from the main portion, and a plastic member having a rectangular parallelepiped shape and accommodating the main portion. The plastic member includes a first end surface that is an end surface in a longitudinal direction, the pin projecting out of the first end surface, a second end surface that is an end surface located on a side opposite to the first end surface in the longitudinal direction, and a side surface that connects the first end surface and the second end surface to each other. The main portion includes a heat generating portion on the side surface. The heat generating portion is exposed externally from the plastic member. The switching element is arranged in the inverter-accommodating chamber such that the longitudinal direction of the plastic member extends in an axial direction of the rotary shaft. A heat dissipation member made of metal is arranged between the switching element and the partitioning wall. The heat dissipation member includes a first heat dissipation portion arranged between the heat generating portion and the partitioning wall, and a second heat dissipation portion that is continuous with the first heat dissipation portion and arranged between the second end surface and the partitioning wall.

### BRIEF DESCRIPTION OF DRAWINGS

FIG. 1 is a cross-sectional side view of a motor-driven compressor.

FIG. 2(a) a is a plan view of an inverter.

FIG. 2(b) is a partially enlarged view of FIG. 2(a).

FIG. 3 is a cross-sectional view taken along line 3-3 in FIG. 2(b).

FIG. 4 is a cross-sectional view taken along line 4-4 in FIG. 2(b).

FIG. 5 is a perspective cross-sectional view of a switching module.

### DESCRIPTION OF EMBODIMENTS

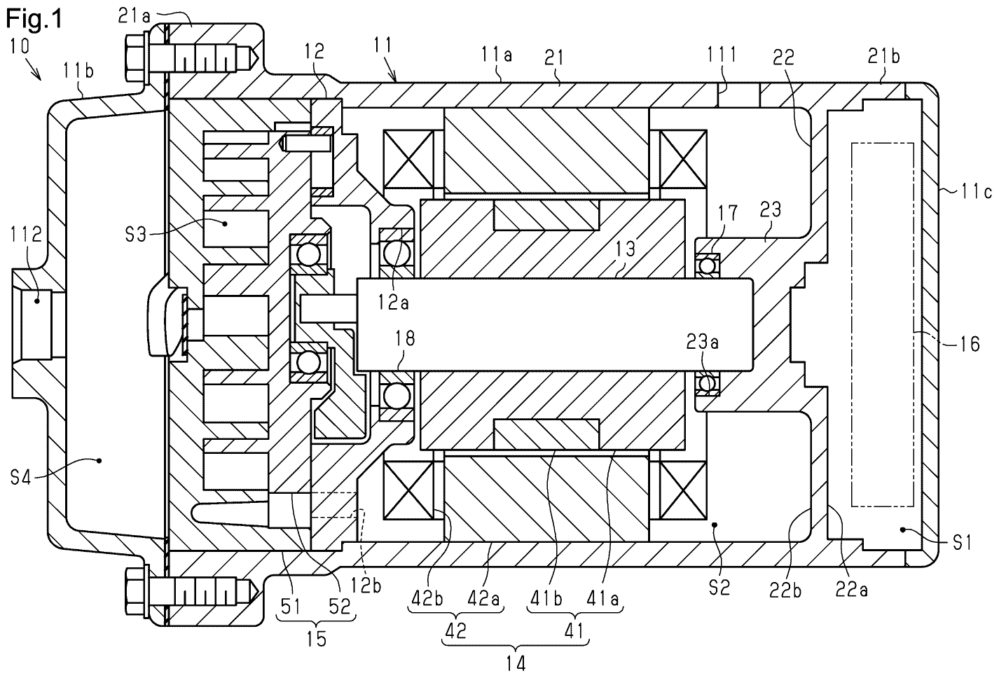

A motor-driven compressor according to one embodiment will now be described with reference to FIGS. 1 to 5. The motor-driven compressor of the present embodiment is applied to, for example, a vehicle air conditioner.

As shown in FIG. 1, the motor-driven compressor 10 includes a housing 11, a shaft support member 12, a rotary shaft 13, an electric motor 14, a compression unit 15, and an inverter 16. The housing 11 is made of metal. The housing 11 of the present embodiment is made of aluminum. The housing 11 accommodates the shaft support member 12, the rotary shaft 13, the electric motor 14, the compression unit 15, and the inverter 16. The electric motor 14 rotates the rotary shaft 13. The compression unit 15 compresses refrigerant, which is fluid, through rotation of the rotary shaft 13. The inverter 16 drives the electric motor 14.

### Housing

The housing 11 includes a first housing member 11a, a second housing member 11b, and a cover 11c.

The first housing member 11a has a cylindrical circumferential wall 21 and a partitioning wall 22. The circumferential wall 21 includes a first end 21a and a second end 21b. The first end 21a and the second end 21b are the end portions of the circumferential wall 21 in the axial direction. The second end 21b is located on a side opposite to the first end 21a in the axial direction of the circumferential wall 21. The partitioning wall 22 partitions the space inside the circumferential wall 21 in the axial direction. The partitioning wall 22 includes a first wall surface 22a and a second wall surface 22b. The first wall surface 22a and the second wall surface 22b are surfaces substantially perpendicular to the axial direction of the circumferential wall 21. The second wall surface 22b is located on a side opposite to the first wall surface 22a in the axial direction of the circumferential wall 21.

The partitioning wall 22 includes a boss 23. The boss 23 projects from the second wall surface 22b of the partitioning wall 22. The boss 23 includes a bearing-accommodating portion 23a recessed from the distal end surface of the boss 23. The bearing-accommodating portion 23a accommodates a first bearing 17.

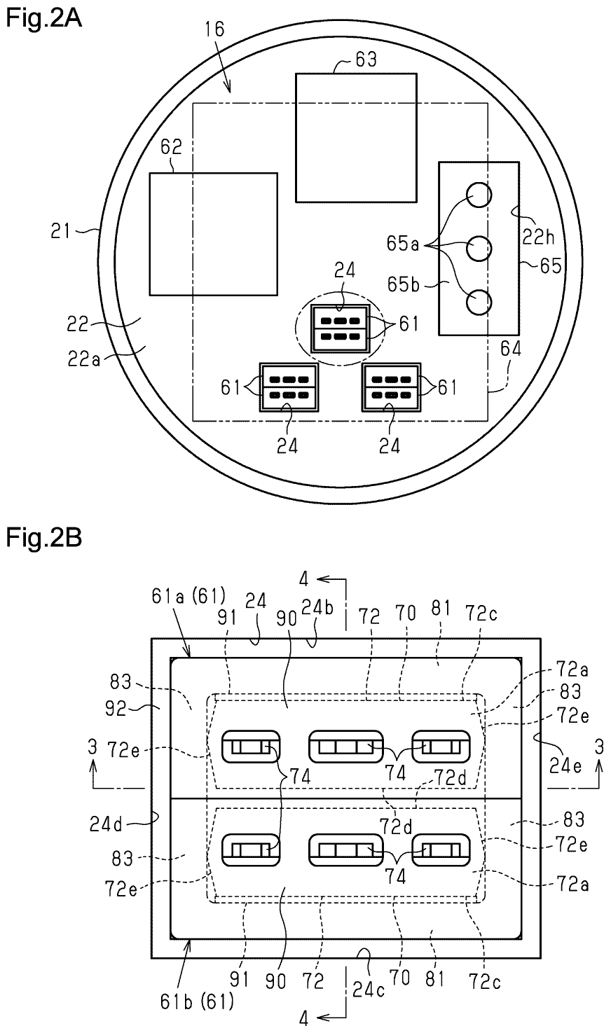

As shown in FIG. 2(a), the partitioning wall 22 includes accommodating recesses 24. The partitioning wall 22 of the present embodiment includes three accommodating recesses 24. The three accommodating recesses 24 are arranged in a V-shape.

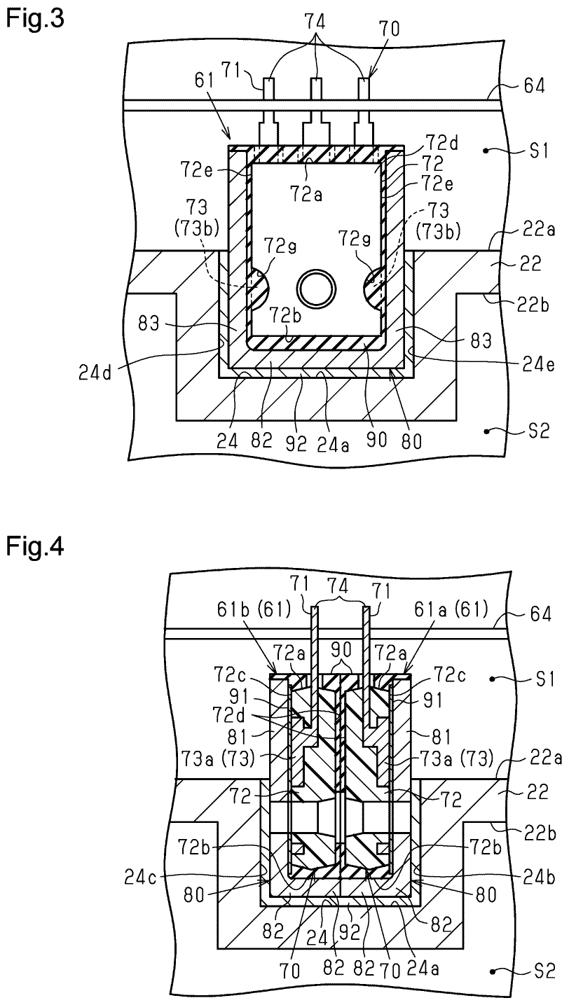

As shown in FIGS. 3 and 4, each accommodating recess 24 is recessed from the first wall surface 22a and projects from the second wall surface 22b. The accommodating recess 24 includes an inner bottom surface 24a and an inner side surface connecting the inner bottom surface 24a and the first wall surface 22a. The inner bottom surface 24a is located on an opposite side of the second wall surface 22b from the first wall surface 22a.

As shown in FIGS. 2(a) and 2(b), the accommodating recesses 24 are each rectangular when viewed in the axial direction of the circumferential wall 21. The inner side surface of the accommodating recess 24 includes a first inner side surface 24b, a second inner side surface 24c, a third inner side surface 24d, and a fourth inner side surface 24e. The first inner side surface 24b and the second inner side surface 24c extend in the longitudinal direction of the accommodating recess 24. The third inner side surface 24d and the fourth inner side surface 24e extend in the transverse direction of the accommodating recess 24.

As shown in FIG. 1, the second housing member 11b is connected to the first end 21a of the circumferential wall 21. The second housing member 11b closes the opening located in the first end 21a of the circumferential wall 21.

The cover 11c is connected to the second end 21b of the circumferential wall 21. The cover 11c closes the opening located at the second end 21b of the circumferential wall 21. An inverter-accommodating chamber S1 is defined by the inner surface of the circumferential wall 21, the first wall surface 22a of the partitioning wall 22, and the inner surface of the cover 11c. The inverter-accommodating chamber S1 accommodates the inverters 16. The first wall surface 22a of the partitioning wall 22 is exposed to the inverter-accommodating chamber S1.

The housing 11 includes a suction port 111 and a discharge port 112. The suction port 111 is formed in the circumferential wall 21. The suction port 111 is located between the first end 21a of the circumferential wall 21 and the partitioning wall 22. The discharge port 112 is formed in the second housing member 11b. The suction port 111 is connected to one end of an external refrigerant circuit (not shown), and the discharge port 112 is connected to the other end of the external refrigerant circuit.

### Shaft Support Member

The shaft support member 12 is accommodated inside the circumferential wall 21. The shaft support member 12 is located between the first end 21a of the circumferential wall 21 and the partitioning wall 22. The shaft support member 12 includes a shaft insertion hole 12a and a connection hole 12b. The shaft insertion hole 12a accommodates second bearings 18.

A suction chamber S2 is defined by the inner surface of the circumferential wall 21, the second wall surface 22b of the partitioning wall 22, and the shaft support member 12. The suction chamber S2 accommodates the electric motor 14. In other words, the suction chamber S2 also serves as a motor-accommodating chamber that accommodates the electric motor 14. The suction chamber S2 and the inverter-accommodating chamber S1 are arranged in the axial direction of the circumferential wall 21. The partitioning wall 22 separates the inverter-accommodating chamber S1 and the suction chamber S2 from each other. The second wall surface 22b of the partitioning wall 22, a surface located on a side opposite to the inner bottom surface 24a, and surfaces located on a side opposite to the inner side surfaces 24b, 24c, 24d, 24e of the wall portion defining the accommodating recess 24 are exposed to the suction chamber S2.

### Rotary Shaft

The rotary shaft 13 is accommodated inside the circumferential wall 21. The rotary shaft 13 extends in the axial direction of the circumferential wall 21. Specifically, the axial direction of the rotary shaft 13 coincides with the axial direction of the circumferential wall 21. The rotary shaft 13 includes a first end inserted into the bearing-accommodating portion 23a. The first end of the rotary shaft 13 is rotatably supported by the boss 23 with the first bearings 17. The rotary shaft 13 includes a second end, which is an end portion opposite to the first end, inserted into the shaft insertion hole 12a of the shaft support member 12. The second end of the rotary shaft 13 is rotatably supported by the shaft support member 12 with the second bearings 18.

### Electric Motor

The electric motor 14 includes a rotor 41 and a stator 42. The rotor 41 includes a cylindrical rotor core 41a and permanent magnets 41b. The rotor core 41a is fixed to the rotary shaft 13. The permanent magnets 41b are embedded in the rotor core 41a. The permanent magnets 41b are arranged at equal pitches in the circumferential direction of the rotor core 41a. The stator 42 surrounds the rotor 41. The stator 42 includes a cylindrical stator core 42a and three-phase motor coils 42b. The stator core 42a is fixed to the inner surface of the circumferential wall 21. The motor coils 42b are wound around the stator core 42a. The rotor 41 rotates when current flows through the motor coils 42b. The rotary shaft 13 rotates integrally with the rotor 41.

### Compression Unit

The compression unit 15 is accommodated inside the circumferential wall 21. The compression unit 15 is located on the opposite side of the shaft support member 12 from the electric motor 14 in the axial direction of the rotary shaft 13. The compression unit 15 of the present embodiment is of a scroll type. The compression unit 15 includes a stationary scroll 51 and an orbiting scroll 52. The stationary scroll 51 is fixed to the inner surface of the circumferential wall 21. The orbiting scroll 52 is arranged to face the stationary scroll 51.

A compression chamber S3, the volume of which is variable, is defined between the stationary scroll 51 and the orbiting scroll 52. The compression chamber S3 is connected to the suction chamber S2 through the connection hole 12b of the shaft support member 12. A discharge chamber S4 is defined by the inner surfaces of the stationary scroll 51 and the second housing member 11b. The compression chamber S3 is connected to the discharge chamber S4.

Refrigerant is drawn into the suction chamber S2 through the suction port 111. The refrigerant drawn into the suction chamber S2 flows into the compression chamber S3 through the connection hole 12b. The refrigerant, having flowed into the compression chamber S3, is compressed through changes in the volume of the compression chamber S3. The compressed refrigerant is discharged to the discharge chamber S4. The refrigerant discharged to the discharge chamber S4 flows out from the discharge port 112 to an external refrigerant circuit. The refrigerant, having flowed to the external refrigerant circuit, flows through a heat exchanger and an expansion valve of the external refrigerant circuit and returns to the suction chamber S2 through the suction port 111. The motor-driven compressor 10 and the external refrigerant circuit form a vehicle air conditioner.

### Inverter

As shown in FIGS. 2(a) and 2(b), the inverter 16 includes six switching modules 61, a coil 62, a capacitor 63, and a circuit board 64. The three-phase switching modules 61 will be described later. The capacitor 63 and the coil 62 form an LC circuit. The LC circuit is a filter circuit for reducing noise included in an input current from an external source. The six switching modules 61, the coil 62, and the capacitor 63 are mounted on the circuit board 64.

The six switching modules 61, the coil 62, the capacitor 63, and the circuit board 64 are arranged on the partitioning wall 22. That is, the inverter 16 is entirely arranged on the partitioning wall 22. The six switching modules 61, the coil 62, and the capacitor 63 are arranged between the partitioning wall 22 and the circuit board 64 in the axial direction of the rotary shaft 13.

A hermetic terminal 65 is arranged on the partitioning wall 22. The hermetic terminal 65 is inserted into a through-hole 22h extending through the partitioning wall 22. The hermetic terminal 65 includes three-phase connection terminals 65a and a terminal-insulating portion 65b. The ends of the connection terminals 65a at one side are connected to the circuit board 64. The ends of the connection terminals 65a at the other side are connected to the motor coils 42b of respective phases. The connection terminals 65a connect the inverters 16 and the electric motor 14. The terminal-insulating portion 65b insulates each of the connection terminals 65a from the partitioning wall 22.

### Switching Module

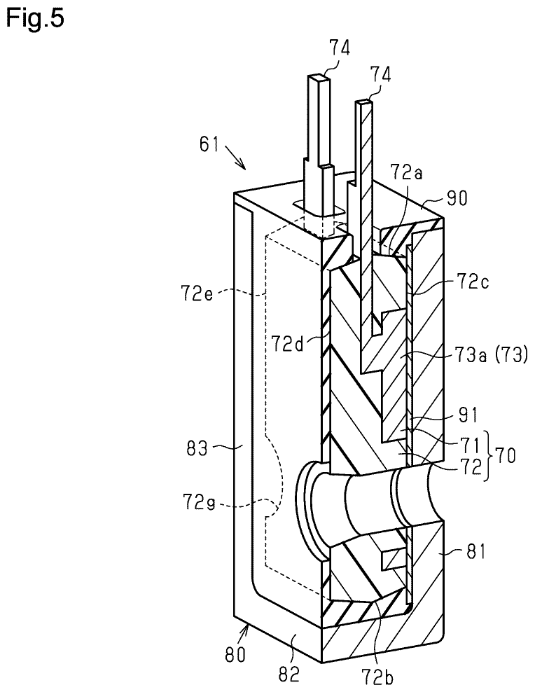

As shown in FIG. 5, each switching module 61 includes a switching element 70, a heat dissipation member 80, and an insulating member 90. The switching element 70 of the present embodiment is an IGBT. Six switching elements 70 perform a switching operation to drive the electric motor 14. The six switching elements 70 form a U-phase upper arm, a U-phase lower arm, a V-phase upper arm, a V-phase lower arm, a W-phase upper arm, and a W-phase lower arm. The heat dissipation member 80 is made of metal. The heat dissipation member 80 of the present embodiment is made of aluminum. The insulating member 90 is made of a material that has insulating properties. The insulating member 90 of the present embodiment is made of rubber.

The switching element 70 includes a conductive member 71 and a plastic member 72 having a rectangular parallelepiped shape. The conductive member 71 includes a plate-shaped main portion 73 and three pins 74 extending from the main portion 73. The plastic member 72 accommodates the main portion 73.

The plastic member 72 includes a first end surface 72a and a second end surface 72b. The first end surface 72a and the second end surface 72b are end surfaces of the plastic member 72 in the longitudinal direction. The second end surface 72b is located on the side opposite to the first end surface 72a in the longitudinal direction of the plastic member 72. The three pins 74 of the conductive member 71 project out of the first end surface 72a of the plastic member 72.

The plastic member 72 includes side surfaces that connect the first end surface 72a and the second end surface 72b to each other in the longitudinal direction. The side surface includes a first side surface 72c, a second side surface 72d, and two third side surfaces 72e. The first side surface 72c and the second side surface 72d are continuous with the long sides of the first end surface 72a and the long sides of the second end surface 72b. The third side surfaces 72e are continuous with the short sides of the first end surface 72a and the short sides of the second end surface 72b. The areas of the first side surface 72c and the second side surface 72d are each greater than the area of the third side surface 72e.

As shown in FIG. 3, the plastic member 72 includes a window portion 72g at a corner connecting the second side surface 72d and one of the third side surfaces 72e. The plastic member 72 includes another window portion 72g at a corner connecting the second side surface 72d and the other one of the third side surfaces 72e.

As shown in FIG. 5, the main portion 73 includes a heat generating portion 73a. The heat generating portion 73a is a portion that is most likely to generate heat in the main portion 73. The heat generating portion 73a is exposed to the outside of the plastic member 72 on the first side surface 72c.

As shown in FIG. 3, the main portion 73 includes exposed portions 73b exposed to the outside of the plastic member 72 through the window portions 72g. The exposed portions 73b are exposed to the outside of the plastic member 72 on the second side surface 72d and the two third side surfaces 72e.

As shown in FIGS. 3 and 4, the heat dissipation member 80 includes a first heat dissipation portion 81, a second heat dissipation portion 82, and two third heat dissipation portions 83. The first heat dissipation portion 81 is rectangular. The second heat dissipation portion 82 extends from one of two short sides of the first heat dissipation portion 81 in the thickness direction of the first heat dissipation portion 81. The second heat dissipation portion 82 is continuous with the first heat dissipation portion 81. The two third heat dissipation portions 83 extend from the two long sides of the first heat dissipation portion 81 in the plate thickness direction of the first heat dissipation portion 81. The two third heat dissipation portions 83 are continuous with the first heat dissipation portion 81. Further, the two third heat dissipation portions 83 are connected to the first heat dissipation portion 81 by the second heat dissipation portion 82 in the transverse direction of the first heat dissipation portion 81. The two third heat dissipation portions 83 are continuous with the second heat dissipation portion 82.

The switching element 70 is arranged in a space surrounded by the first heat dissipation portion 81, the second heat dissipation portion 82, and the two third heat dissipation portions 83. The second end surface 72b of the plastic member 72 faces the second heat dissipation portion 82. The first side surface 72c and the heat generating portion 73a of the plastic member 72 face the first heat dissipation portion 81. In the present embodiment, a heat dissipation sheet 91 is arranged between the first heat dissipation portion 81 and the assembly including the first side surface 72c and the heat generating portion 73a. One of the surfaces of the heat dissipation sheet 91 is in contact with the first side surface 72c and the heat generating portion 73a. The other one of the surfaces of the heat dissipation sheet 91 is in contact with the first heat dissipation portion 81. The two third side surfaces 72e of the plastic member 72 face the two third heat dissipation portions 83.

In the present embodiment, the insulating member 90 is insert-molded in a state in which the switching element 70 is arranged in the heat dissipation member 80. Thus, the switching element 70 and the heat dissipation member 80 are integrated by the insulating member 90.

The insulating member 90 is located between the second end surface 72b of the plastic member 72 and the second heat dissipation portion 82. The insulating member 90 is also located between the two third side surfaces 72e of the plastic member 72 and the two third heat dissipation portions 83. Further, the insulating member 90 covers the first end surface 72a and the second side surface 72d of the plastic member 72. In other words, the insulating member 90 covers five surfaces of the plastic member 72 excluding the first side surface 72c. Thus, the exposed portions 73b are covered by the insulating member 90.

As shown in FIG. 2(a), the six switching modules 61 are accommodated in the inverter-accommodating chamber S1 such that the longitudinal direction of the plastic members 72 extends in the axial direction of the rotary shaft 13. The pins 74 of the switching element 70 are each connected to the circuit board 64. The six switching modules 61 are accommodated in the accommodating recess 24. In the present embodiment, a single accommodating recess 24 accommodates switching modules 61 of the same phase. In the following, one of the switching modules 61 of the same phase is referred to as a first switching module 61a, and the other one of the switching modules 61 of the same phase is referred to as a second switching module 61b.

As shown in FIGS. 2(b) and 4, the first switching module 61a and the second switching module 61b are arranged such that the second side surfaces 72d of the plastic members 72 face each other through the insulating member 90.

The first heat dissipation portion 81 of the first switching module 61a faces the first inner side surface 24b of the accommodating recess 24 through a thermal grease 92. The second heat dissipation portion 82 of the first switching module 61a faces the inner bottom surface 24a of the accommodating recess 24 through the thermal grease 92. One of the two third heat dissipation portions 83 of the first switching module 61a faces the third inner side surface 24d of the accommodating recess 24 through the thermal grease 92. The other one of the two third heat dissipation portions 83 of the first switching module 61a faces the fourth inner side surface 24e of the accommodating recess 24 through the thermal grease 92.

The first heat dissipation portion 81 of the second switching module 61b faces the second inner side surface 24c of the accommodating recess 24 through the thermal grease 92. The second heat dissipation portion 82 of the second switching module 61b faces the inner bottom surface 24a of the accommodating recess 24 through the thermal grease 92. One of the two third heat dissipation portions 83 of the second switching module 61b faces the third inner side surface 24d of the accommodating recess 24 through the thermal grease 92. The other one of the two third heat dissipation portions 83 of the second switching module 61b faces the fourth inner side surface 24e of the accommodating recess 24 through the thermal grease 92.

In other words, in each the switching module 61, the first heat dissipation portion 81 is arranged between the heat generating portion 73a of the switching element 70 and the partitioning wall 22. The second heat dissipation portion 82 is arranged between the second end surface 72b of the switching element 70 and the partitioning wall 22. The two third heat dissipation portions 83 are arranged between the two third side surfaces 72e of the switching element 70 and the partitioning wall 22.

### OPERATION OF PRESENT EMBODIMENT

Operation of the present embodiment will now be described.

The conductive member 71 of the switching element 70 generates heat during operation of the inverter 16. The heat of the switching element 70 is transferred to the first heat dissipation portion 81 through the heat dissipation sheet 91. The heat, transferred to the first heat dissipation portion 81, is transferred to the partitioning wall 22 through the thermal grease 92. The partitioning wall 22 is exposed to the suction chamber S2. The partitioning wall 22 is cooled by refrigerant drawn into the suction chamber S2. Thus, the switching element 70 is cooled by the refrigerant, drawn into the suction chamber S2, through the first heat dissipation portion 81 and the partitioning wall 22.

The heat of the switching element 70, transferred to the first heat dissipation portion 81, is also transferred to the second heat dissipation portion 82 continuous with the first heat dissipation portion 81. The heat transferred to the second heat dissipation portion 82 is transferred to the partitioning wall 22 through the thermal grease 92. In other words, the switching element 70 is cooled by the refrigerant drawn into the suction chamber S2 through the second heat dissipation portion 82 and the partitioning wall 22. This improves the cooling performance of the switching element 70.

Further, the heat of the switching element 70, transferred to the first heat dissipation portion 81, is also transferred to the two third heat dissipation portions 83 continuous with the first heat dissipation portion 81. The heat, transferred to the two third heat dissipation portions 83, is transferred to the partitioning wall 22 through the thermal grease 92. In other words, the switching element 70 is cooled by the refrigerant drawn into the suction chamber S2 through the two third heat dissipation portions 83 and the partitioning wall 22. This further improves the cooling performance of the switching element 70.

### Advantages of Present Embodiment

The present embodiment has the following advantages.

(1) The heat dissipation member 80 made of metal is arranged between the switching element 70 and the partitioning wall 22. The heat dissipation member 80 includes the first heat dissipation portion 81 and the second heat dissipation portion 82. The first heat dissipation portion 81 is arranged between the heat generating portion 73a and the partitioning wall 22. The second heat dissipation portion 82 is continuous with the first heat dissipation portion 81 and arranged between the second end surface 72b of the plastic member 72 and the partitioning wall 22. The heat of the switching element 70 is dissipated to the partitioning wall 22 through the first heat dissipation portion 81 and is also dissipated to the partitioning wall 22 through the second heat dissipation portion 82 continuous with the first heat dissipation portion 81. This improves the cooling performance of the switching element 70.

(2) The switching element 70 is arranged in the inverter-accommodating chamber S1 such that the longitudinal direction of the plastic member 72 extends in the axial direction of the rotary shaft 13. Thus, the area of the switching element 70 as viewed in the axial direction of the rotary shaft 13 is reduced as compared with a case in which the longitudinal direction of the plastic member 72 extends in a direction orthogonal to the axial direction of the rotary shaft 13 and the heat generating portion 73a is in contact with the first wall surface 22a of the partitioning wall 22. This avoids an increase in the size of the inverter 16 as viewed in the axial direction of the rotary shaft 13. As a result, an increase in the size of the housing 11 as viewed in the axial direction of the rotary shaft 13 is avoided. In the present embodiment, the inverter 16 is entirely arranged on the partitioning wall 22. Thus, in addition to the switching element 70, other heat generating members such as the coil 62 and the capacitor 63 are cooled.

(3) The partitioning wall 22 includes the accommodating recess 24, which is recessed from the first wall surface 22a and projects from the second wall surface 22b. The switching element 70 is arranged in the accommodating recess 24. The area of the partitioning wall 22 exposed to the suction chamber S2 is increased. Thus, the partitioning wall 22 is more readily cooled by refrigerant drawn into the suction chamber S2. This further improves the cooling performance of the switching element 70.

(4) The heat dissipation member 80 includes the two third heat dissipation portions 83, which are continuous with the first heat dissipation portion 81 and arranged between the two third side surfaces 72e and the partitioning wall 22. Thus, the heat of the switching element 70 is dissipated to the partitioning wall 22 through the first heat dissipation portion 81 and the second heat dissipation portion 82 and also through the two third heat dissipation portions 83. This further improves the cooling performance of the switching element 70.

(5) The switching element 70 and the heat dissipation member 80 are integrated by the insulating member 90 made of rubber. The insulating member 90 is arranged between the second end surface 72b and the second heat dissipation portion 82 and between the two third side surfaces 72e and the two third heat dissipation portions 83. Thus, the switching element 70 and the heat dissipation member 80 are easy to handle as compared to a case in which the switching element 70 and the heat dissipation member 80 are separate from each other.

(6) The main portion 73 of each of the switching elements 70 includes the exposed portions 73b exposed on the second side surface 72d and the third side surfaces 72e. Thus, when multiple switching elements 70 are accommodated in the inverter-accommodating chamber S1, it is necessary to ensure an insulation distance between the exposed portions 73b. The switching elements 70 of the present embodiment are IGBTs used under high voltage, causing an insulation distance to be particularly required.

In the present embodiment, the insulating member 90 covers the second side surface 72d of the plastic member 72 in addition to the second end surface 72b and the two third side surfaces 72e. Thus, the exposed portions 73b are covered by the insulating member 90. This readily allows for an insulation distance to be ensured between the exposed portions 73b. In this case, the inverters 16 is not increased in size as compared to a case in which an insulation distance between the exposed portions 73b is ensured by increasing the distance between switching elements 70.

(7) The insulating member 90 covers five surfaces of the plastic member 72 excluding the first side surface 72c. The switching element 70 is pressed toward the first heat dissipation portion 81 by the insulating member 90. Thus, the heat generating portion 73a and the heat dissipation sheet 91 are in close contact with each other, and the heat dissipation sheet 91 and the first heat dissipation portion 81 are in close contact with each other.

(8) The heat dissipation member 80 may include a fourth heat dissipation portion that faces the second side surface 72d of the plastic member 72, in addition to the first to third heat dissipation portions 81 to 83. However, when the fourth heat dissipation portion is provided, the heat dissipation member 80 has a quadrangular tube shape with a closed end in which the second heat dissipation portion 82 serves as a bottom wall. This will make the formation of the heat dissipation member 80 more difficult. Further, the fourth heat dissipation portion is not continuous with the first heat dissipation portion 81. Thus, the fourth heat dissipation portion has a smaller substantial cooling effect on the switching element 70 than the second heat dissipation portion 82 and the third heat dissipation portion 83. Thus, the heat dissipation member 80 includes the first heat dissipation portion 81, the second heat dissipation portion 82, and the two third heat dissipation portions 83 as heat dissipation portions in a preferable manner.

### Modifications

The above embodiment may be modified as described below. The above-described embodiment and the following modifications can be combined as long as the combined modifications remain technically consistent with each other.

The partitioning wall 22 may include a projection projecting from the first wall surface 22a instead of the accommodating recess 24. The projection has, for example, a quadrangular tube shape extending in the axial direction of the rotary shaft 13. The switching module 61 is arranged inside the projection. Specifically, the first heat dissipation portion 81 is arranged between the heat generating portion 73a and the inner surface of the projection. The second heat dissipation portion 82 is arranged between the second end surface 72b of the plastic member 72 and the first wall surface 22a of the partitioning wall 22. The third heat dissipation portions 83 are each arranged between the third side surfaces 72e of the plastic member 72 and the inner surfaces of the projection.

In this case, the heat of the switching element 70 is transferred to the first heat dissipation portion 81, and is also transferred to the second heat dissipation portion 82 and the two third heat dissipation portions 83 continuous with the first heat dissipation portion 81. The heat transferred to the second heat dissipation portion 82 is transferred to the partitioning wall 22. The heat transferred to the first heat dissipation portion 81 and the third heat dissipation portions 83 is transferred to the projection. The projection is part of the partitioning wall 22. Thus, the projection is cooled by refrigerant drawn into the suction chamber S2. As a result, the switching element 70 is cooled by the refrigerant drawn into the suction chamber S2 through the partitioning wall 22.

The structure of the housing 11 may be changed.

For example, the housing 11 may include, instead of the first housing member 11a, a motor housing having a cylindrical shape with a closed end and a tubular inverter housing connected to the bottom wall of the motor housing. In this case, the suction chamber S2 is defined by the inner surface of the motor housing and the shaft support member 12. The inverter-accommodating chamber S1 is defined by the inner surface of the inverter housing and the inner surface of the cover 11c. The bottom wall of the motor housing is a partitioning wall that separates the suction chamber side S2 and the inverter-accommodating chamber S1 from each other.

The quantity of the accommodating recesses 24 of the partitioning wall 22 may be changed.

For example, the three accommodating recesses 24 of the above embodiment may be joined to form one accommodating recess 24.

For example, the partitioning wall 22 may have six accommodating recesses 24. In this case, one accommodating recess 24 accommodates one switching module 61.

The arrangement of the switching modules 61 on the partitioning wall 22 may be changed in accordance with the arrangement of other components of the inverter 16. For example, U-phase switching modules 61, V-phase switching modules 61, and W-phase switching modules 61 may be arranged in alignment.

The switching element 70 may be a switching element different from an IGBT.

The switching module 61 does not need to include the insulating member 90. In this case, the switching element 70 and the heat dissipation member 80 may be separate from each other, or may be fixed to each other by an adhesive or the like and integrated.

The heat dissipation member 80 does not need to be made of aluminum as long as heat dissipation member 80 is made of metal having high thermal conductivity.

The heat dissipation member 80 may lack both or either one of the two third heat dissipation portions 83 as long as the heat dissipation member 80 includes the first heat dissipation portion 81 and the second heat dissipation portion 82.

The heat dissipation member 80 may include a fourth heat dissipation portion that faces the second side surface 72d of the plastic member 72, in addition to the first heat dissipation portion 81, the second heat dissipation portion 82, and the two third heat dissipation portions 83. In this case, the heat dissipation member 80 has a quadrangular tube shape with a closed end in which the second heat dissipation portion 82 serves as a bottom wall.

The insulating member 90 does not need to be made of rubber as long as the insulating member 90 is formed of a material that has insulating properties.

The heat dissipation sheet 91 may be omitted. In this case, the first side surface 72c and the heat generating portion 73a of the plastic member 72 are in contact with the first heat dissipation portion 81.

The thermal grease 92 may be replaced with a potting material (resin potting). Further, the thermal grease 92 may be omitted. In this case, the heat dissipation portions 81 to 83 are in contact with the partitioning wall 22.

The compression unit 15 is not limited to the scroll type as long as refrigerant is compressed by the rotation of the rotary shaft 13.

The motor-driven compressor 10 of the above embodiment is used in the vehicle air conditioner. However, the present disclosure is not limited to this. For example, the motor-driven compressor 10 may be mounted on a fuel cell electric vehicle and may use the compression unit 15 to compress air that is fluid supplied to a fuel cell.

1. A motor-driven compressor, comprising:
a rotary shaft;
an electric motor that rotates the rotary shaft;
a compression unit that compresses a fluid through rotation of the rotary shaft;
an inverter that drives the electric motor and includes a switching element; and
a metal housing including a partitioning wall that separates a suction chamber and an inverter-accommodating chamber from each other, the suction chamber accommodating the electric motor and drawing in the fluid, the inverter-accommodating chamber accommodating the inverter, wherein
the switching element includes:
a conductive member including a main portion and a pin projecting from the main portion; and
a plastic member having a rectangular parallelepiped shape and accommodating the main portion,
the plastic member includes:
a first end surface that is an end surface in a longitudinal direction, the pin projecting out of the first end surface;
a second end surface that is an end surface located on a side opposite to the first end surface in the longitudinal direction; and
a side surface that connects the first end surface and the second end surface to each other,
the main portion includes a heat generating portion on the side surface, the heat generating portion being exposed externally from the plastic member,
the switching element is arranged in the inverter-accommodating chamber such that the longitudinal direction of the plastic member extends in an axial direction of the rotary shaft,
a heat dissipation member made of metal is arranged between the switching element and the partitioning wall, and
the heat dissipation member includes:
a first heat dissipation portion arranged between the heat generating portion and the partitioning wall; and
a second heat dissipation portion that is continuous with the first heat dissipation portion and arranged between the second end surface and the partitioning wall.

2. The motor-driven compressor according to claim 1, wherein
the partitioning wall includes:
a first wall surface that is an end surface of the partitioning wall in the axial direction of the rotary shaft and is exposed to the inverter-accommodating chamber;
a second wall surface that is an end surface located on a side opposite to the first wall surface in the axial direction of the rotary shaft; and
an accommodating recess that is recessed from the first wall surface and projects from the second wall surface, and
the switching element is arranged in the accommodating recess.

3. The motor-driven compressor according to claim 1, wherein
the side surface includes:
a first side surface in which the heat generating portion is exposed;
a second side surface on a side opposite to the first side surface; and
two third side surfaces that connect the first side surface and the second side surface to each other, and
the heat dissipation member includes two third heat dissipation portions that are continuous with the first heat dissipation portion and arranged between the third side surfaces and the partitioning wall.

4. The motor-driven compressor according to claim 3, wherein the switching element and the heat dissipation member are integrated by an insulating member made of rubber, the insulating member being arranged between the second end surface and the second heat dissipation portion and between the two third side surfaces and the two third heat dissipation portions.

5. The motor-driven compressor according to claim 4, wherein
the switching element included in the inverter includes multiple switching elements,
the main portions of the switching elements each include an exposed portion exposed externally from the plastic member on the second side surface and the third side surface, and
the insulating member covers the second side surface.
